(19) United States
(12) Patent Application Publication
(10) Pub. No.: US 2026/0065431 A1
(43) Pub. Date: Mar. 5, 2026

(54) VENDOR-AGNOSTIC AI IMAGE PROCESSING

(71) Applicant: KONINKLIJKE PHILIPS N.V., EINDHOVEN (NL)

(72) Inventors: THOMAS KOEHLER, NORDERSTEDT (DE); FRANK BERGNER, HAMBURG (DE); MICHAEL GRASS, BUCHHOLZ IN DER NORDHEIDE (DE); CHRISTIAN WUELKER, HAMBURG (DE)

(21) Appl. No.: 19/106,651

(22) PCT Filed: Aug. 21, 2023
(86) PCT No.: PCT/EP2023/072884

§ 371 Date: Feb. 26, 2025

Related U.S. Application Data
(60) Provisional application No. 63/402,101, filed on Aug. 30, 2022.

(51) Int. Cl. G06T 5/60; G06T 7/00

(52) U.S. Cl. CPC G06T 5/60; G06T 7/0012; G06T 2207/10081; G06T 2207/20084; G06T 2207/30168

(57) ABSTRACT

Images are processed while remaining agnostic as to an image source. An input image to be processed is retrieved. A first value or set of values for an image metric associated with the input image is determined, and a first filter is generated based on a relationship between the first value or set of values and a target value or set of values. The first filter is then applied to the input image to generate a working image having a second value or set of values for the image metric substantially similar to the target value or set of values for the image metric. The working image is processed using a standardized image processing methodology. An output is generated, which may be an image, based on the processed working image and outputs the output.

### FIELD OF THE INVENTION

The present disclosure generally relates to systems and methods for processing images using trained neural networks. In particular, the present disclosure relates to systems and methods for processing images while remaining agnostic as to the image source.

### BACKGROUND

Conventionally, obtaining images through standard imaging modalities, such as Computed Tomography (CT) scans, results in image artifacts and noise embedded into such images. Further, a system processing such images may seek to preemptively gain some information about the contents of the scan, such as an identification of the contents. Accordingly, images are generally filtered and reconstructed to initially convert measured data to images and then processed using algorithms for, e.g., denoising, segmenting, or preemptively identifying contents.

Reducing levels of radiation to be applied to patients is desirable, and AI processing, such as denoising, is a powerful tool to reduce radiation doses applied to patients in practice, and is already implemented regularly. AI based approaches allow increased image quality in low dose imaging by removing artifacts associated with such reduced doses. Similar AI based approaches can be used to provide additional imaging benefits, such as metal artifact reduction and motion artifact reduction, as well as analytical benefits, such as segmentation and classification of image contents.

Accordingly, input images are typically processed using various AI based image processing methodologies prior to being presented to users. However, AI image processing typically only performs reliably if an input image provided to the AI tools, such as a convolutional neural network (CNN), is within a distribution range of images used to train the corresponding algorithm or network. Further, given limited neural network capacity, a network will perform better if training is done on a relatively narrow distribution of images. For instance, a network trained on body images typically performs better on body images than a network trained on body and head images.

Another example for this problem of generalization is related to the use of standardized reconstruction filters for AI denoising, for example, in order to support a broad range of reconstruction filters to be applied later. In some embodiments, a dedicated reconstruction pipeline may be utilized in which a standard high-resolution filter is used to generate input images for a neural network, and desired filter characteristics are applied only after a generic AI denoising step.

While this approach of a generalized reconstruction pipeline may be feasible if the entire reconstruction-chain is under control, and therefore images are received having characteristics expected by the AI based image processing methodologies to be implemented, such an approach cannot be applied to images generated by other vendors having characteristics different than those expected.

There is a need for machine-learning algorithms and processes for CT image processing that can be made independent of characteristics of an input image to be processed.

### SUMMARY

Methods are provided for machine learning based image processing. The provided method allows for processing images in accordance with standardized image processing while remaining agnostic as to a source of the input image.

A method is provided in which an input image to be processed is retrieved, such as from an imaging system. The method then determines a first value or set of values for an image metric associated with the input image.

The method then generates a first filter based on a relationship between the first value or set of values for the image metric and a target value or set of values for the image metric.

The method then applies the first filter to the input image to generate a working image. The working image has a second value or set of values for the image metric substantially similar to the target value or set of values for the image metric.

The working image is then processed using a standardized image processing methodology based on the target value or set of values for the image metric. The method then generates an output based on the processed working image and outputs the output.

In some embodiments, the output may be an output image based on the processed working image. In other embodiments, it may be a segmentation or classification result independent of the output image.

In some embodiments, the output is an output image, and the method further comprises generating the output image by first applying a second filter to the working image following the standardized image processing. The second filter may be an inverse of the first filter.

In some embodiments, the determination of the value or set of values is based on acquisition parameters associated with the input image. Such acquisition parameters may be extracted from DICOM files associated with the input image retrieved.

In some embodiments, the determination of the first value or set of values is based on visual characteristics of the input image retrieved. In some such embodiments, the determination of the first value or set of values is based on an evaluation of white space in the input image. The method may then include retrieving a calibration image generated by an imaging system that generated the input image. Such a calibration image may be an air scan from the imaging system.

In some embodiments in which the determination of the first value or set of values is based on visual characteristics of the input image, the determination may be based on a trained neural network independent of the standardized image processing methodology.

In some embodiments in which the determination of the first value or set of values is based on visual characteristics of the input image, the method may proceed to identify at least one homogenous image region and derive a noise power spectrum associated with the identified homogenous image region. The first value or set of values may then be determined based on the derived noise power spectrum.

In some embodiments, the image metric is defined by one of sharpness of the image, a noise power spectrum of the image, or a combination thereof.

In some embodiments, the standardized image processing methodology is a trained artificial intelligence based process, and the target value or set of values for the image metric is an average value or set of values of the image metric calculated for training materials used to train the standardized image processing methodology. In some such embodiments, the standardized image processing methodology is a convolutional neural network.

In some embodiments, the standardized image processing methodology is for denoising, segmenting, or classifying a target image. In some such embodiments, the standardized image processing methodology is tuned based on a hypothetical target image having the target value or set of values for the image metric.

In some embodiments, the image metric is a modulation transfer function for the image, and the relationship between the first value or set of values and the target value or set of values is defined by the shape of the modulation transfer function relative to a Nyquist frequency of an image grid of the corresponding image. In some such embodiments, the method includes determining that the first value or set of values of the modulation transfer function generates zero values at frequencies at which the target modulation transfer function generates non-zero values. In such embodiments, the method includes down-sampling the input image prior to applying the first filter.

In some such embodiments, the output is an output image and the method includes generating the output image by applying a second filter to the working image following processing. The second filter may then be an inverse of the first filter. The method may then also include up-sampling the output image after applying the second filter and prior to outputting the output image in order to restore the size of the input image.

In some embodiments, the image metric is a noise-power spectrum (NPS) of the corresponding image, and the standardized image processing methodology is a denoising process.

In some embodiments, the image metric is based on a resolution or voxel size of the corresponding image and a signal to noise ratio (SNR) of the corresponding image, and the standardized image processing methodology is a segmentation process.

In some embodiments, the image metric is based on a resolution or voxel size of the corresponding image, a signal to noise ratio (SNR) of the corresponding image, and a field of view (FOV) of the corresponding image, and the standardized image processing methodology is a classification process.

In some embodiments, first value or set of values is an array or matrix of values defining the image metric.

### BRIEF DESCRIPTION OF THE DRAWINGS

FIG. 1 is a schematic diagram of a system according to one embodiment of the present disclosure.

FIG. 2 illustrates an exemplary imaging device according to one embodiment of the present disclosure.

FIG. 3 illustrates a method for processing images in accordance with this disclosure.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

It is important to note that the embodiments disclosed are only examples of the many advantageous uses of the innovative teachings herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality.

Generally, an image is processed using various image processing methodologies designed to visually improve images or to otherwise add information or functionality to images. This may take the form of specialized reconstruction filters targeting specific body parts, as well as various denoising, segmentation, or classification processes.

Further, in the context of Computed Tomography (CT) based medical imaging, for example, different image processors, such as machine-learning algorithms which may take the form of Convolutional Neural Networks (CNNs), may be used to process images. These image processors are then trained, in the case of machine learning algorithms, on various images having an expected form. In particular, the training images generally come from a known source or set of sources, and have known characteristics, such as sharpness and noise power spectrum (NPS). These characteristics may be used to define an image metric associated with the corresponding images.

Such an image metric can take various forms, as discussed in more detail below. In some embodiments, the image metric can be a modulation transfer function (MTF) associated with an imaging system. Because sharpness and NPS can have a unique relationship to an MTF associated with a particular imaging system and with images acquired by way of that imaging system, the MTF can be a convenient way to reference such an image metric used in various embodiments. It is understood that various other image metrics are usable as well.

It is noted that sharpness can be measured in different ways. As such, sharpness typically refers to perceived image sharpness. However, in some embodiments, sharpness may refer to spatial resolution, such that a measure of sharpness may relate to how well small objects can be detected and distinguished from each other in an image.

Because CNNs are trained on training images having a particular value for an image metric relied upon, such as the MTF, or may have values for such an image metric within a relatively narrow range, such training is specific to the images having similar visual characteristics to those used during the training. Accordingly, for a CNN to be universally usable for processing images, it could be trained independently on images from any source that might be utilized for acquiring images. However, due to training requirements, better performance is typically achieved by training a neural network on a relatively narrow distribution of input images when defined in terms of the corresponding image metric, such as MTFs.

Where a user has control of an entire imaging pipeline, including processing equipment and the image source, such as a CT scanning unit, the values for the defined image metric of all images may be known. However, assumptions often cannot be made with respect to the values of the corresponding image metric of images acquired from third party vendors or from unknown image sources. Accordingly, a transformation may be applied to an input image drawn from a third party vendor or unknown source in order to force the image metric to better correspond to expected values for the image metric, thereby allowing for better performance during image processing.

In medical imaging other than CT, such as Magnetic Resonance Imaging (MRI) or Positron Emission Tomography (PET), different methods may be used for processing images, and resulting images may take different forms. In this disclosure, embodiments are discussed in terms of CT imaging. However, it will be understood that the methods and systems described herein may be used in the context of other imaging modalities as well.

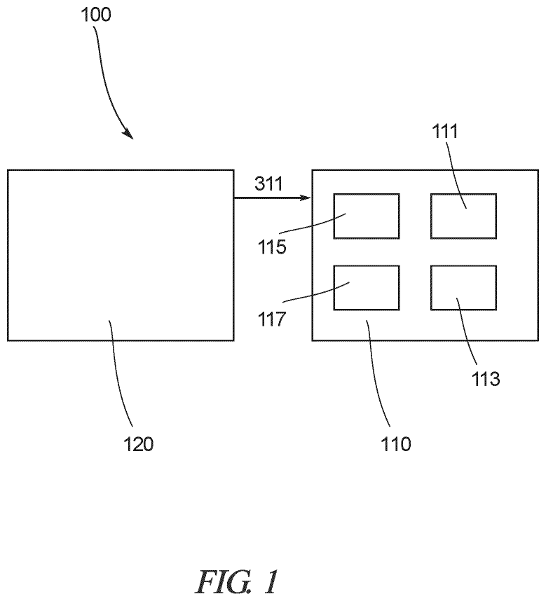

FIG. 1 is a schematic diagram of a system 100 according to one embodiment of the present disclosure. As shown, the system 100 typically includes a processing device 110 and an imaging device 120.

The processing device 110 may apply processing routines to images or measured data, such as projection data, received from the imaging device 120. The processing device 110 may include a memory 113 and processor circuitry 111. The memory 113 may store a plurality of instructions. The processor circuitry 111 may couple to the memory 113 and may be configured to execute the instructions. The instructions stored in the memory 113 may comprise processing routines, as well as data associated with processing routines, such as machine learning algorithms, and various filters for processing images. While all data is described as being stored in the memory 113, it will be understood that in some embodiments, some data may be stored in a database, which may itself either be stored in the memory or stored in a discrete system, or stored in a cloud.

The processing device 110 may further include an input 115 and an output 117. The input 115 may receive information, such as images or measured data, from the imaging device 120. The output 117 may output images, such as filtered images, to a user or a user interface device. Alternatively, the output 117 may output information about the images, such as the result of a segmentation or classification result. The output 117 may include a monitor or display.

In some embodiments, the processing device 110 may relate to the imaging device 120 directly. In alternate embodiments, the processing device 110 may be distinct from the imaging device 120, such that it receives images or measured data for processing by way of a network or other interface at the input 115.

In some embodiments, the imaging device 120 may include an image data processing device, and a spectral or conventional CT scanning unit for generating the CT projection data when scanning an object (e.g., a patient).

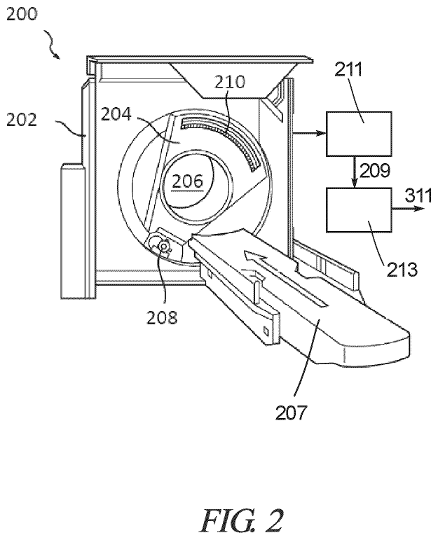

FIG. 2 illustrates an exemplary imaging device 200 according to one embodiment of the present disclosure. It will be understood that while a CT imaging device is shown, and the following discussion is in the context of CT images, similar methods may be applied in the context of other imaging devices, and images to which these methods may be applied may be acquired in a wide variety of ways.

In an imaging device in accordance with embodiments of the present disclosure, the CT scanning unit may be adapted for performing multiple axial scans and/or a helical scan of an object in order to generate the CT projection data. In an imaging device in accordance with embodiments of the present disclosure, the CT scanning unit may comprise an energy-resolving photon counting image detector. The CT scanning unit may include a radiation source that emits radiation for traversing the object when acquiring the projection data.

In the example shown in FIG. 2, the CT scanning unit 200, e.g. the Computed Tomography (CT) scanner, may include a stationary gantry 202 and a rotating gantry 204, which may be rotatably supported by the stationary gantry 202. The rotating gantry 204 may rotate about a longitudinal axis around an examination region 206 for the object when acquiring the projection data. The CT scanning unit 200 may include a support 207 to support the patient in the examination region 206 and configured to pass the patient through the examination region during the imaging process.

The CT scanning unit 200 may include a radiation source 208, such as an X-ray tube, which may be supported by and configured to rotate with the rotating gantry 204. The radiation source 208 may include an anode and a cathode. A source voltage applied across the anode and the cathode may accelerate electrons from the cathode to the anode. The electron flow may provide a current flow from the cathode to the anode, such as to produce radiation for traversing the examination region 206.

The CT scanning unit 200 may comprise a detector 210. The detector 210 may subtend an angular arc opposite the examination region 206 relative to the radiation source 208. The detector 210 may include a one-or two-dimensional array of pixels, such as direct conversion detector pixels. The detector 210 may be adapted for detecting radiation traversing the examination region 206 and for generating a signal indicative of an energy thereof.

The CT scanning unit 200 may further include generators 211 and 213. The generator 211 may generate tomographic projection data 209 based on the signal from the detector 210. The generator 213 may receive the tomographic projection data 209 and, in some embodiments, generate a raw image 311 of the object based on the tomographic projection data 209. In some embodiments, the tomographic projection data 209 may be provided to the input 115 of the processing device 110, while in other embodiments the raw image 311 is provided to the input of the processing device.

The various physical characteristics of the CT scanning unit 200, as well as processing applied to any output of the CT scanning unit by the system 100, result in values for an image metric characterizing an image to be processed. For example, the imaging system may generate images having a particular noise power spectrum (NPS) and having a known level of sharpness, among other characteristics. Such an image metric may be, for example, a modulation transfer function (MTF) characterizing the output of the imaging system 100.

Generally, automated image processing methodologies, such as AI image processing tasks, are trained using a set of training images. Such training images are drawn from an imaging system 100, such as that described above, having defined values for the image metric. Using the MTF as an example, where all training images are drawn from a set of images having an identical MTF, since they were drawn from a single imaging system, or having values for their MTFs within a narrow band, since they were drawn from imaging systems from a single known manufacturer, the resulting AI image processing methodology will give good results when used to process images having the same or similar MTF characteristics.

However, when applied to images retrieved from imaging systems provided by different manufacturers, the trained AI image processing algorithm would not provide good results.

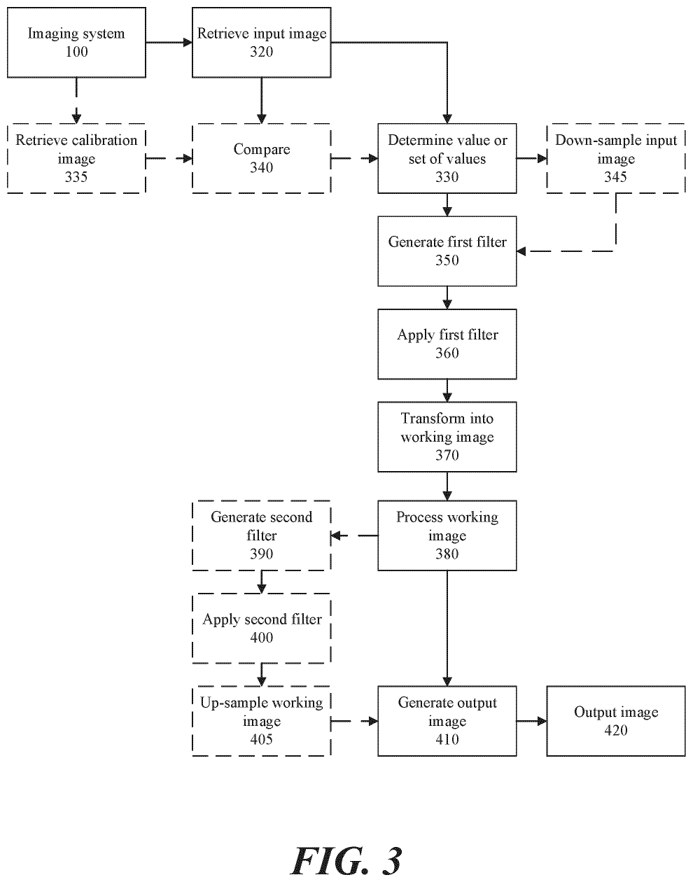

FIG. 3 illustrates a method for processing images in accordance with this disclosure. As discussed above, a method is provided for applying a standardized image processing methodology to input images while remaining agnostic as to certain characteristics of the input images. For example, the standardized image processing methodology may be AI based, such as an application of a trained neural network, and the methodology may be based on images acquired by way of a well-known imaging system. The method may then process input images using the standardized image processing methodology while remaining agnostic as to the source of the input images. The method allows for such processing even if the standardized image processing methodology would not be able to directly process, or would not be able to provide acceptable results with respect to the acquired images.

As shown, the method includes first retrieving (320) an input image to be processed. The method then determines (at 330) a first value or set of values for an image metric associated with the input image. As noted above, the image metric may be an MTF associated with an imaging system that the image was retrieved from. Alternatively, the image metric may be a metric defined by or based on various characteristics of the image. In any event, the first value or set of values determined for the input image may define one or more visual characteristics of the input image such that it can be compared to other images.

In some embodiments, the determination of the value or set of values is based on acquisition parameters associated with the input image. In such an embodiment, the acquisition parameters may be extracted from DICOM files associated with the input image. In such an embodiment, the value or set of values may define an MTF, as discussed above.

In some embodiments, the determination of the value or set of values may be based on visual characteristics of the input image retrieved. For example, the determination may be based on an evaluation of white space in the input image. In such an embodiment, the method may further comprise retrieving (at 335) a calibration image generated by an imaging system 100 that generated the input image. The calibration image may be an air scan from the same imaging system 100, for example.

The input image, or just the white space contained therein, may then be compared (at 340) to the air scan retrieved from the imaging system 100 in order to determine the first value or set of values.

In some embodiments, the first value or set of values may be determined by applying a trained neural network, or other AI based algorithm, to the input image. Such a trained neural network may be independent of the standardized image processing methodology to be applied by the method.

In some embodiments, the first value or set of values may be determined by identifying at least one homogenous image region and deriving a noise power spectrum (NPS) associated with the identified homogenous image region. The first value or set of values may then be determined based on the derived NPS.

Generally, a number of visual characteristics of the input image may be used to define the image metric. For example, the image metric may be defined by one of sharpness of the image, a noise power spectrum (NPS) of the image, or a combination of those characteristics. In some embodiments, the image metric may be based on a resolution or voxel size of the input image and a signal to noise ratio (SNR) of the corresponding image. Additional characteristics may be considered as well, including a field of view (FOV).

The value or set of values determined (at 330) may take the form of a single variable defining the image metric or may take the form of a set of values in an array or matrix defining the image metric. As such, when a value or set of values is discussed herein, it is referring to any set of values that are used to characterize an image in the context of such an image metric.

Once the first value or set of values for the image metric is determined (at 330), the method proceeds to generate a first filter (350) based on a relationship between the first value or set of values for the image metric and a target value or set of values for the image metric. Such a first filter may then be applied (360) to the input image to transform the input image into a working image (370) having a second value or set of values for the image metric different than the first value or set of values.

The first filter is generated as a custom filter designed to transform the first image, such that the value or values of the metric correspond to or are made similar to the target value or set of values. This may be by enhancing or damping various frequency components in the image to make it match the corresponding values for a target image. Accordingly, after the transformation into the working image (at 370) is completed, the second value or set of values for the image metric is then substantially similar to the target value or set of values for the image metric. Generally, the target value or set of values for the image metric correspond to values associated with a known imaging system for which a standardized image processing methodology was designed. In the case of an AI based image processing methodology, such as a neural network, the target value or set of values correspond to values for the image metric for images on which the neural network was trained.

For example, where an AI based image processing algorithm, or neural network such as a convolutional neural network (CNN), was trained on a set of images drawn from a known imaging system, resulting in a known MTF, and where the input image is drawn from an imaging system from a different manufacturer resulting in a different MTF, the first filter may transform the input image into a working image having an MTF similar to or identical to the MTF of images from the known imaging system. This transformation allows the target images to be effectively processed using the AI based image processing algorithm, even if the input image could not be so processed.

In some cases, not all training images share a value or set of values for the image metric. This may occur where the image metric is an MTF in a case where training images are drawn from different imaging systems. Alternatively, this may occur where the image metric is based on the image itself rather than the source system. In such embodiments, the target value or set of values for the image metric may be an average value or set of values of the image metric calculated for the training materials used to train the standardized image processing methodology.

In some embodiments, the standardized image processing methodology may be tuned based on a hypothetical target image having the target value or set of values for the image metric. This may occur where the training images do not directly correspond to an expected set of images, or where the standardized image processing methodology is likely to be used in scenarios different than initially trained for.

When the second value or set of values is described as substantially similar to the target value or set of values, it is understood that such similarity is sufficient so as to allow the AI based image processing algorithm trained on images having the target value or set of values for the image metric to process the working image. In some embodiments, the first filter may be generated (at 350) such that the second value or set of values corresponds exactly to the target value or set of values. In other embodiments, such second value or set of values may be within a range of the target value or set of values. The bounds of such substantial similarity may vary depending on the particular standardized image processing methodology applied in a particular implementation.

Accordingly, after transforming the input image into the working image (at 370), the working image may be processed (380) using a standardized image processing methodology based on the target value or set of values for the image metric.

Once processed, the method may generate an output (410), in the form of information or an output image based on the processed working image and output (420) the resulting information or output image. In some embodiments where the output is an output image, the method may optionally include generating a second filter (390) to revert the second value or set of values for the image metric to the first values. This may be by inverting the first filter (generated at 350). The second filter may then be applied (400) to the working image after processing (at 380) in order to generate the output image (at 410).

Where the output is an output image, such an output image (generated at 410) may then be output having the image metric of the known imaging system for which the image processing methodology was designed, or it may be transformed (at 400) by applying the second filter and may therefore be output having the image metric associated with the imaging system that the image was retrieved from initially. As such, when the imaging system that the image was retrieved from initially has a unique aesthetic associated with its output, the method described herein may be used to apply a standardized image processing methodology while still presenting the output image (at 420) familiar to users of the source system.

The method described herein may be used to apply a wide variety of standardized image processing methodologies. For example, the standard image processing methodology may be a denoising process, a segmentation process, or a classification process applied to the contents of the image in some embodiments, and the image metric for which values are retrieved (at 330) is defined based on a processing methodology to be applied.

For example, in some embodiments, the image metric is an NPS of the corresponding image, as discussed above, and the standardized image processing methodology is a denoising process.

Alternatively, in some embodiments, the image metric is based on a resolution or voxel size of the corresponding image and an SNR of the corresponding image, and the standardized image processing methodology is a segmentation process.

Alternatively, in some embodiments, the image metric is based on a resolution or voxel size of the corresponding image, an SNR, and a FOV of the corresponding image, and the standardized image processing methodology is a classification process.

Further, in some embodiments, the method may be used to apply a variety of standardized image processing methodologies. Accordingly, prior to determining the value or set of values for the image metric (at 330), a user may select a standardized image processing methodology to be applied. The user selection may then be used by the method to define the image metric and only then determine the value or set of values (at 330) prior to proceeding to generate the first filter (at 350).

As noted above, a standardized image processing methodology may comprise multiple filters applied consecutively. This approach may be used to create a more generalized image processing methodology that can process, for example, distinct body parts or tissue types. In such implementations used for AI denoising, a first standard, high-resolution filter may be used to generate an input image for the neural network. The desired filter characteristics may be applied only after applying the first standard filter. For example, where different reconstruction filters may generally be used to denoise and process images of bone and soft tissue, a first generalized filter may be used to denoise both images and only after such a generalized filter is applied might a second filter be used to emphasize desired characteristics.

Such a standardized image processing methodology may only be feasible if an entire reconstruction chain is under control of the user implementing the system. Accordingly, the method described herein may be used to initially modify an input image drawn from a third party imaging system so that it corresponds to the expected image parameters of this type of standardized image processing methodology.

In some embodiments, the image metric is a modulation transfer function (MTF) for the image, as discussed above. The relationship between the MTF of the input image and the target MTF is then used to generate the first filter. Such a relationship may be defined by the shape of the MTF relative to a Nyquist frequency of an image grid of the corresponding image. For instance, a 512² image with 250 mm field-of-view (FOV) and a Gaussian shape MTF with 50% @ 8 line pairs per centimeter (lp/cm) looks to the neural network equivalent to a 512² image with 500 mm FOV and Gaussian shape MTF with 50% @ 4 lp/cm.

Initially, it is noted that the images would be viewed differently by a neural network implementing the standardized image processing methodology due to distinct MTFs and a different FOV. Accordingly, the first filter may include a cropping operation, such that the working image has the FOV that the standardized image processing methodology was trained on.

In some embodiments, the relationship between the MTF of the input image and the target MTF is evaluated to determine that the MTF of the input image generates zero values at frequencies at which the target MTF generates non-zero values. In such an embodiment, prior to applying the first filter (at 360), the input image may be down-sampled (345). Such down-sampling may be before or after the generation of the first filter (at 350).

Such down-sampling exploits the fact that if the MTF falls down to zero below the Nyquist frequency defined by the image grid, the image can be down-sampled without loss of information. Due to the scaling invariance, the down-sampled image can then be pre-processed to match the desired frequency response using the first filter (at 360) as discussed above.

In such embodiments, after applying the standardized image processing methodology (at 380) and after applying the second filter (at 400), the working image may be up-sampled (405) in order to restore the original image size. The output image may then be output (420) at its original size.

In some embodiments where the shape of the MTF is evaluated with respect to the Nyquist frequency, in addition to or instead of triggering a down-sampling operation (at 345), the method may also implement a deconvolution or image sharpening or deblurring process as part of the first filter, which may assist in segmentation or classification. This may be in addition to a cropping of the image, so as to ensure that the working image has the FOV that the standardized image processing methodology was trained on.

The methods according to the present disclosure may be implemented on a computer as a computer implemented method, or in dedicated hardware, or in a combination of both. Executable code for a method according to the present disclosure may be stored on a computer program product. Examples of computer program products include memory devices, optical storage devices, integrated circuits, servers, online software, etc. Preferably, the computer program product may include non-transitory program code stored on a computer readable medium for performing a method according to the present disclosure when said program product is executed on a computer. In an embodiment, the computer program may include computer program code adapted to perform all the steps of a method according to the present disclosure when the computer program is run on a computer. The computer program may be embodied on a computer readable medium.

While the present disclosure has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the disclosure.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A computer-implemented method for processing images, comprising:
retrieving an input image to be processed;
determining a first value or set of values for an image metric associated with the input image;
generating a first filter based on a relationship between the first value or set of values for the image metric and a target value or set of values for the image metric;
applying the first filter to the input image to generate a working image, the working image having a second value or set of values for the image metric substantially similar to the target value or set of values for the image metric;
processing the working image using a standardized image processing methodology based on the target value or set of values for the image metric; and
generating an output based on the processed working image.

2. The method of claim 1, wherein the output is an output image, and further comprising generating the output image by applying a second filter to the working image after processing, the second filter being an inverse of the first filter.

3. The method of claim 1, wherein the determination of the first value or set of values is based on acquisition parameters associated with the input image.

4. The method of claim 3, wherein the acquisition parameters are extracted from DICOM files associated with the retrieved input image.

5. The method of claim 1, wherein the determination of the first value or set of values is based on visual characteristics of the retrieved input image.

6. The method of claim 5, wherein the determination of the first value or set of values is based on an evaluation of white space in the input image, and wherein the method further comprises retrieving a calibration image generated by an imaging system that generated the input image, the calibration image being an air scan from the imaging system.

7. The method of claim 5, wherein the determination of the first value or set of values is based on a trained neural network independent of the standardized image processing methodology.

8. The method of claim 5, further comprising identifying at least one homogenous image region and deriving a noise power spectrum associated with the identified at least one homogenous image region, and wherein the derived noise power spectrum is used to determine the first value or at least one value of the first set of values.

9. The method of claim 1, wherein the image metric is defined by one of sharpness of the image, a noise power spectrum of the image, or a combination thereof.

10. The method of claim 1, wherein the standardized image processing methodology is a trained artificial intelligence based process, and wherein the target value or set of values for the image metric is an average value or set of values of the image metric calculated for training materials used to train the standardized image processing methodology.

11. The method of claim 10, wherein the standardized image processing methodology is a convolutional neural network, and wherein the standardized image processing methodology is used for denoising, segmenting, or classifying a target image.

12. The method of claim 11, wherein the standardized image processing methodology is tuned based on a hypothetical target image having the target value or set of values for the image metric.

13. The method of claim 1, wherein the image metric is a modulation transfer function for the image, and the relationship between the first value or set of values and the target value or set of values is defined by the shape of the modulation transfer function relative to a Nyquist frequency of an image grid of the corresponding image.

14. The method of claim 13, further comprising determining that the first value or set of values of the modulation transfer function generates zero values at frequencies at which the target modulation transfer function generates non-zero values, and down-sampling the input image prior to applying the first filter.

15. The method of claim 14, wherein the output is an output image, the method further comprising generating the output image by applying a second filter to the working image following processing, the second filter being an inverse of the first filter, and up-sampling the output image after applying the second filter and prior to outputting the output image in order to restore the size of the input image.

16. The method of claim 1, wherein the image metric is a noise-power spectrum (NPS) of the corresponding image, and wherein the standardized image processing methodology is a denoising process.

17. The method of claim 1, wherein the image metric is based on a resolution or voxel size of the corresponding image and a signal to noise ratio (SNR) of the corresponding image, and wherein the standardized image processing methodology is a segmentation process.

18. The method of claim 1, wherein the image metric is based on a resolution or voxel size of the corresponding image, a signal to noise ratio (SNR) of the corresponding image, and a field of view (FOV) of the corresponding image, and wherein the standardized image processing methodology is a classification process.

19. A computer-implemented system for processing images, comprising:
a memory that stores a plurality of instructions; and
processor circuitry that couples to the memory and is configured to execute the plurality of instructions to:
retrieve an input image to be processed;
determine a first value or set of values for an image metric associated with the input image;
generate a first filter based on a relationship between the first value or set of values for the image metric and a target value or set of values for the image metric;
apply the first filter to the input image to generate a working image, the working image having a second value or set of values for the image metric substantially similar to the target value or set of values for the image metric;
process the working image using a standardized image processing methodology based on the target value or set of values for the image metric; and
generate an output based on the processed working image.
